(19) United States
(12) Patent Application Publication
(10) Pub. No.: US 2006/0265492 A1
(43) Pub. Date: Nov. 23, 2006

(54) On-demand test environment using automated chat clients

(76) Inventor: Daniel E. Morris, Round Rock, TX (US)

Correspondence Address: Greg Goshorn, P.C., 9600 Escarpment, auite 745-9, AUSTIN, TX, 78749, US

(21) Appl. No.: 11/130,894

(22) Filed: May 17, 2005

(51) Int. Cl. G06F 15/173; G06F 15/16

(52) U.S. Cl. 709/224; 709/227

(57) ABSTRACT

Provided is a computer system and method for interactive and on-demand test environment using automated chat clients. A computer-implemented method includes receiving by a server a request from a computer in the computer test environment to instantiate a chat session with the test computer in the computer test environment wherein the server hosts an instant messaging service, the request identifying the test computer as a chat user; instantiating a chat session in response to the request between the test computer and at least one computer in the computer test environment; accessing data concerning test results performed on the test computer by the server to enable responding to chat session data requests; and responding to chat requests by one or more participants to the chat session via parsing the data concerning the test results accessed by the server. The computer-implemented method also includes broadcasting instant messages from the test computer to the participants of a chat session.

### TECHNICAL FIELD

The present invention relates generally to delivery of electronic messages, referred to as “chat,” and, more specifically, to a system and method for using automated chat clients in a test environment.

### BACKGROUND OF THE INVENTION

Large distributed test environments can include hundreds of test computers and multiple platforms. Distributed test environments are used to test any number or variety of software products. Software testing can include functional testing, operating system testing, testing for games, software development, database environments, communication software and any software wherein a large distributed test environment with many machines would be suitable. Such environments typically generate reports and store them in a central repository. Typically, results can be emailed following a request, or a user can log onto a local test computer to gather test results.

A problem with the current methods for gathering test results is that users requiring test results must specifically ask for the results, know where and how to obtain the results and obtain the information via a web source, such as through a virtual private network (VPN), an email request or physically logging into a test computer and acquiring results. The known methods for acquiring results are cumbersome and require a user to remember to obtain results. Furthermore, testing can include unpredictable end times or cause problems that are not easily resolved by looking at results gathered after a test has completed running.

What is needed is a system and method for determining the status of software testing in a distributed environment that operates in near real time.

### SUMMARY OF THE INVENTION

Provided is a computer system and method for interactive and on-demand test environment using automated chat clients. A computer-implemented method for acquiring test results from one or more tests performed in a computer test environment including at least one test computer includes receiving by a server a request from a computer in the computer test environment to instantiate a chat session with the test computer in the computer test environment wherein the server hosts an instant messaging service, the request identifying the test computer as a chat user; instantiating a chat session in response to the request between the test computer and at least one computer in the computer test environment; accessing data concerning test results performed on the test computer by the server to enable responding to chat session data requests; and responding to chat requests by one or more participants to the chat session via parsing the data concerning the test results accessed by the server. The data concerning the test computer can include one or more test results and test status of a test program running on at least the test computer. The computer-implemented method can include broadcasting one or more messages from the test computer to the one or more participants, wherein the broadcasting is according to a hierarchy supplied by the test computer, the hierarchy identifying participants in an order to receive the messages and matching appropriate participants to a subset of the messages, the broadcasting being performed periodically or in accordance with markers present in a test program.

The data concerning the test computer can include test data loaded on the test computer or the server, the data concerning the test computer being configured to be accessed via a chat session and configured to be parsed.

Another embodiment is directed to a method for a test computer to disseminate test result data in near real time. The computer-implemented method includes instantiating a chat session independent of human interaction via an application programming interface (API) as a function related to invoking a test on the test computer; contacting predetermined users as participants to the chat session; and sending one or more messages to one or more of the participants via the API in response to markers present in a test program running on the test computer. In one embodiment, the API interacts with a script identifying the participants to be sent the one or more messages. The function can result in the chat session being instantiated upon occurrence of invoking the test, a predetermined time after the invoking the test, reaching one or more markers included in the test, or receiving an indication to instantiate the chat session in response to test parameters determined after invoking the test. The markers can cause the API to deliver predetermined messages via a chat application.

In one embodiment, The computer-implemented method includes responding to messages received by the participants via a predefined set of responses associated with a status of the test. For example, the API can be configured to access a dictionary of key words, the key words invoking a real-time response from the test computer to provide a response to the participant sending a message.

Another embodiment is directed to a computer system including a processor; a memory coupled to the processor, the memory including a module configured to enable an interactive chat session from the computer system to one or more participants of a chat session, the module configured to identify the computer system as a chat user and automatically instantiate the chat session to enable near real time access by one or more participants of the chat session of data of data concerning testing by a test computer in a computer test environment. In an embodiment, the module is configured to access a dictionary of key words, the key words invoking a near real-time response from the test computer to provide a response to a participant in the chat session sending a message. Also in an embodiment, the module is configured to enable disseminating test result data from the test computer, the module including an application programming interface (API) responsive to instantiation of a chat session independent of human interaction by invoking a test on the test computer. The API contacts predetermined users as participants to the chat session.

In an embodiment, the API responds in near real-time to the one or more participants of the chat session to provide the data concerning the testing by the test computer in the computer test environment. Also, in the embodiment, the API interacts with a script identifying the participants to the chat session. In an embodiment, the API responds to one or more messages received by the one or more of the participants in the chat session via a predefined set of responses associated with a status of the test and contacts the one or more participants in the chat session as a function of one or more markers present in a test program running on the test computer. In an embodiment, the markers cause the API to deliver predetermined messages via a chat application.

### BRIEF DESCRIPTION OF THE DRAWINGS

A better understanding of the present invention can be obtained when the following detailed description of the disclosed embodiments is considered in conjunction with the following drawings, in which:

FIG. 1 is a block diagram of an exemplary computer architecture that supports the claimed subject matter;

FIG. 2 is a block diagram of a distributed computer environment appropriate for embodiments of the present invention.

FIG. 3 is a flow diagram illustrating a method in accordance with an embodiment of the present invention.

FIG. 4 is a flow diagram illustrating a method in accordance with an embodiment of the present invention.

FIG. 5 is a flow diagram illustrating a method in accordance with an embodiment of the present invention.

### DETAILED DESCRIPTION OF THE DRAWINGS

Those with skill in the computing arts will recognize that the disclosed embodiments have relevance to a wide variety of applications and architectures in addition to those described below. In addition, the functionality of the present invention can be implemented in software, hardware, or a combination of software and hardware. The hardware portion can be implemented using specialized logic; the software portion can be stored in a memory or recording medium and executed by a suitable instruction execution system such as a microprocessor.

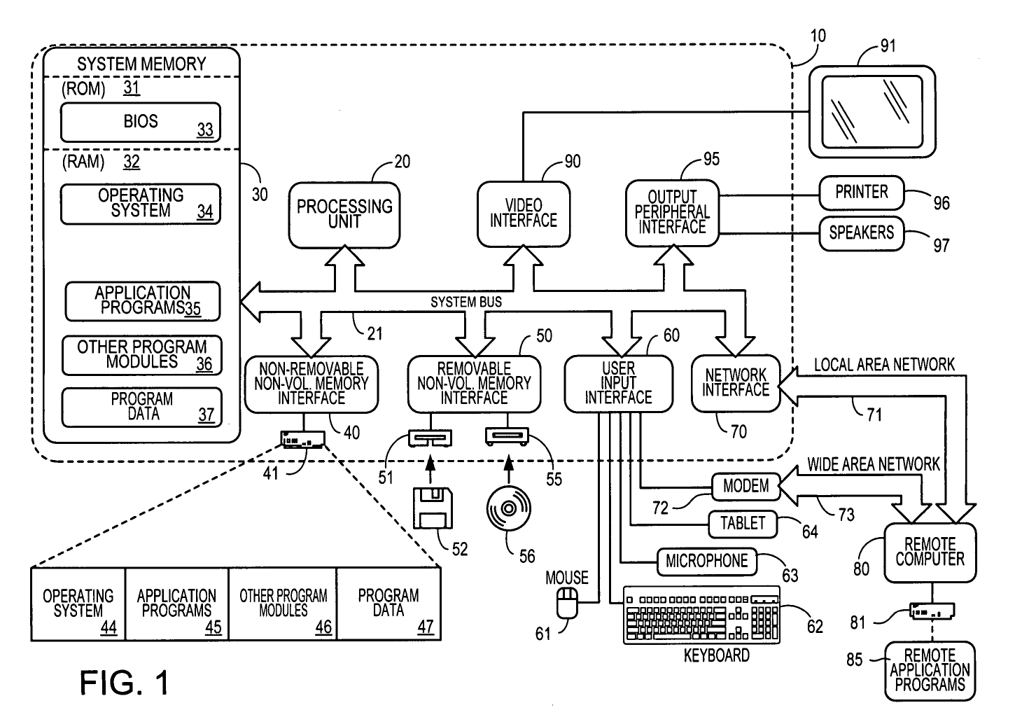

With reference to FIG. 1, an exemplary computing system for implementing the embodiments and includes a general purpose computing device in the form of a computer 10. Components of the computer 10 may include, but are not limited to, a processing unit 20, a system memory 30, and a system bus 21 that couples various system components including the system memory to the processing unit 20. The system bus 21 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 10 typically includes a variety of computer readable media. Computer readable media can be any available media that can be accessed by the computer 10 and includes both volatile and nonvolatile media, and removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computer 10. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 30 includes computer storage media in the form of volatile and/or nonvolatile memory such as read only memory (ROM) 31 and random access memory (RAM) 32. A basic input/output system 33 (BIOS), containing the basic routines that help to transfer information between elements within computer 10, such as during start-up, is typically stored in ROM 31. RAM 32 typically contains data and/or program modules that are immediately accessible to and/or presently being operated on by processing unit 20. By way of example, and not limitation, FIG. 1 illustrates operating system 34, application programs 35, other program modules 36 and program data 37.

The computer 10 may also include other removable/non-removable, volatile/nonvolatile computer storage media. By way of example only, FIG. 1 illustrates a hard disk drive 41 that reads from or writes to non-removable, nonvolatile magnetic media, a magnetic disk drive 51 that reads from or writes to a removable, nonvolatile magnetic disk 52, and an optical disk drive 55 that reads from or writes to a removable, nonvolatile optical disk 56 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 41 is typically connected to the system bus 21 through a non-removable memory interface such as interface 40, and magnetic disk drive 51 and optical disk drive 55 are typically connected to the system bus 21 by a removable memory interface, such as interface 50.

The drives and their associated computer storage media, discussed above and illustrated in FIG. 1, provide storage of computer readable instructions, data structures, program modules and other data for the computer 10. In FIG. 1, for example, hard disk drive 41 is illustrated as storing operating system 44, application programs 45, other program modules 46 and program data 47. Note that these components can either be the same as or different from operating system 34, application programs 35, other program modules 36, and program data 37. Operating system 44, application programs 45, other program modules 46, and program data 47 are given different numbers hereto illustrate that, at a minimum, they are different copies. A user may enter commands and information into the computer 10 through input devices such as a tablet, or electronic digitizer, 64, a microphone 63, a keyboard 62 and pointing device 61, commonly referred to as a mouse, trackball or touch pad. Other input devices (not shown) may include a joystick, game pad, satellite dish, scanner, or the like. These and other input devices are often connected to the processing unit 20 through a user input interface 60 that is coupled to the system bus, but may be connected by other interface and bus structures, such as a parallel port, game port or a universal serial bus (USB). A monitor 91 or other type of display device is also

The computer 10 may operate in a networked environment using logical connections to one or more remote computers, such as a remote computer 80. The remote computer 80 may be a personal computer, a server, a router, a network PC, a peer device or other common network node, and typically includes many or all of the elements described above relative to the computer 10, although only a memory storage device 81 has been illustrated in FIG. 1. The logical connections depicted in FIG. 1 include a local area network (LAN) 71 and a wide area network (WAN) 73, but may also include other networks. Such networking environments are commonplace in offices, enterprise-wide computer networks, intranets and the Internet. For example, in the present invention, the computer system 10 may comprise the source machine from which data is being migrated, and the remote computer 80 may comprise the destination machine. Note however that source and destination machines need not be connected by a network or any other means, but instead, data may be migrated via any media capable of being written by the source platform and read by the destination platform or platforms.

When used in a LAN networking environment, the computer 10 is connected to the LAN through a network interface or adapter 70. When used in a WAN networking environment, the computer 10 typically includes a modem 72 or other means for establishing communications over the WAN 73, such as the Internet. The modem 72, which may be internal or external, may be connected to the system bus 21 via the user input interface 60 or other appropriate mechanism. In a networked environment, program modules depicted relative to the computer 10, or portions thereof, may be stored in the remote memory storage device. By way of example, and not limitation, FIG. 1 illustrates remote application programs 85 as residing on memory device 81. It will be appreciated that the network connections shown are exemplary and other means of establishing a communications link between the computers may be used.

In the description that follows, the invention will be described with reference to acts and symbolic representations of operations that are performed by one or more computers, unless indicated otherwise. As such, it will be understood that such acts and operations, which are at times referred to as being computer-executed, include the manipulation by the processing unit of the computer of electrical signals representing data in a structured form. This manipulation transforms the data or maintains it at locations in the memory system of the computer which reconfigures or otherwise alters the operation of the computer in a manner well understood by those skilled in the art. The data structures where data is maintained are physical locations of the memory that have particular properties defined by the format of the data. However, although the invention is being described in the foregoing context, it is not meant to be limiting as those of skill in the art will appreciate that some of the acts and operation described hereinafter can also be implemented in hardware.

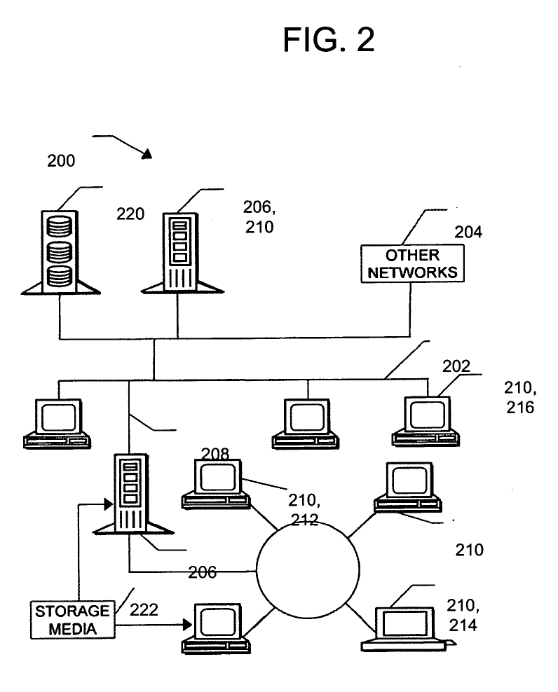

According to an embodiment, computer 10 can be configured as a computer that includes an instant messaging application in accordance with an embodiment. One of the many computer networks suited for use with the present invention is indicated generally at 200 in FIG. 2. Embodiments include those in which the system 200 contains one or more domains or realms, such as one or more Microsoft Windows NT domains or Kerberos realms. The system 200 can include a local area network 202 connectable to other networks 204, including other LANs or portions of the Internet or an intranet, through a gateway or similar mechanism.

The system 200 includes several file or object servers 206 that are connected by network signal lines 208 to one or more network clients 210. The servers 206 and clients 210 can be configured by those of skill in the art in a wide variety of ways to operate according to embodiments described herein. The servers 206 can be configured as Internet servers, as intranet servers, as directory service providers or name servers, as software component (e.g., COM or Java) or other object servers, or as a combination thereof. The servers 206 can be single processor or multiprocessor machines. The servers 206 and clients 210 each include an addressable storage medium such as random access memory and/or a nonvolatile storage medium such as a magnetic or optical disk.

Suitable network clients 210 include, without limitation, personal computers 212, laptops 214, workstations 216, dumb terminals, information appliances, and/or embedded processing systems. The signal lines 208 may include twisted pair, coaxial, or optical fiber cables, telephone lines, satellites, microwave relays, modulated AC power lines, and other data transmission “wires” known to those of skill in the art. Signals according to the invention may be embodied in such “wires” and/or in the addressable storage media (volatile and/or nonvolatile).

A given computer may function both as a client, such as one of network client computers 210, and/or as a server 206. Although particular individual and network computer systems and components are shown, those of skill in the art will appreciate that the present invention also works with a variety of other networks and computers.

The servers 206 and the clients 210 are capable of using floppy drives, tape drives, optical drives or other means to read storage media 222. Suitable storage medium 222 includes a magnetic, optical, or other computer-readable storage device having a specific physical substrate configuration. Suitable storage devices include floppy disks, hard disks, tape, CD-ROMs, PROMs, RAM and other computer system storage devices. The substrate configuration represents data and instructions which cause the computer system to operate in a specific and predefined manner as described herein. Thus, the medium 222 tangibly embodies a program, functions, and/or instructions that are executable by the servers 206 and/or network clients 210 to perform embodiments substantially as described herein.

Embodiments described herein are directed to using a distributed test environment. FIG. 2 represents an exemplary network capable of being implemented as a distributed test environment. Each of servers 206 and clients 210 can be implemented as a test computer to test a software program. Servers 206 and clients 210 can also be implemented as combined test computers to test software programs requiring a combination of machines running simultaneously, serially or in other configurations possible in a distributed test environment.

The computers 206 and 210 can be implemented as target “test” machines” and include a client running thereon. In an embodiment, each target “test” machine can be configured to orchestrate a test execution and reporting mechanism for testing software. A client executes a test on the target machine and the results of those tests are reported/saved. In one embodiment, the results are saved on a local machine. In other embodiments, the results are saved on a remote machine or automatically reported via an email client application.

According to embodiments herein, the “test” client can include one or more programmable application programming interfaces (APIs). An API refers to a software interface that allows a computer program to invoke another computer program, subsystem, component, library, service or the like. In an embodiment, the “test” client invokes, via at least one API, an instant messaging client application. More specifically, computers 206 and 210 are configured to operate the “test” client that instantiates an API upon completion of, for example, to run an instant messaging client capable of instantiating real time text messaging, referred to as “chat,” messages.

A “chat,” also referred to as an instant messaging, or “IM” is a type of communications service that enables a kind of private chat room with another individual or group of individuals to communicate in real time over the Internet, analogous to a telephone conversation but using text-based, not voice-based, communication. Typically, the instant messaging system provides an alert whenever a party on a private list is online. Chat sessions can take place between two people or more. In an embodiment, however, the client invoking the API is not a person. Rather, a “test” client identifies the computer on which the client is operating as if the machine is a person. Thus, each machine shown in FIG. 2 as part of a distributed computing system is uniquely identified on an instant messaging server, in like manner as a person would be identified.

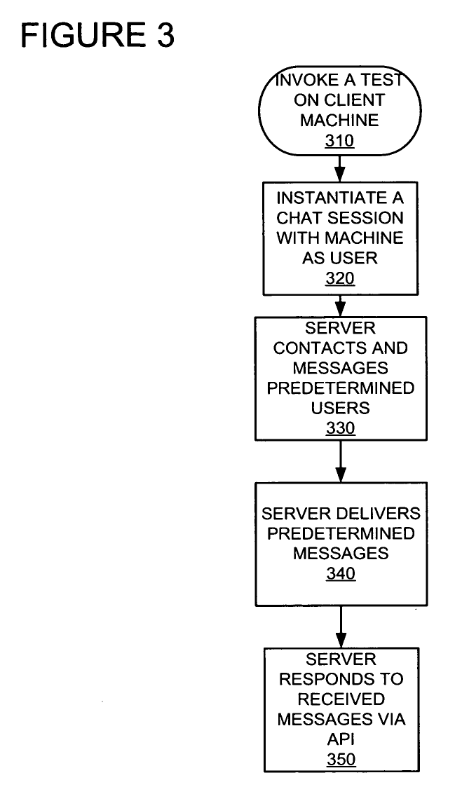

Referring to FIG. 3, a flow diagram illustrates an embodiment for enabling a test client in a distributed computing system to provide data via a chat session. Block 310 provides for invoking a test on one or more client machines. Block 320 provides for instantiating a chat session including each of the client machines in the distributed computing system as chat users. The instantiation could be via an API that interfaces with a chat application upon a determination that a test has been started. The API could include a module that interacts with a script identifying the users to be included on messages, and interacts with the test program. Block 330 provides for automatically contacting and messaging predetermined users to the chat session. The predetermined users could be individuals associated with the test that could benefit from the information concerning the status and results of the testing.

Block 340 provides for delivering predetermined messages to users from the test computer. The predetermined messages can be generated via the test program by having the test program include markers that cause the API to deliver predetermined messages via the chat application. For example, if the test program has a marker at a half-way point or has indicia of test completion capable of being marked, the API could be associated with those markers and include a message to be instantly messaged upon reaching those markers.

In one embodiment, the predetermined users could be associated with the markers such that those users responsible for certain portions of a testing procedure are notified only when relevant markers are reached by the test client. Likewise, the API can be configured to send certain users messages only if there is a failure or if testing completed unsuccessfully or successfully. For example, a user/machine could be associated with determining statistics of the testing and interested only in determining whether a set of tests passed or failed. The API could be configured so that such a user/machine only receives pass or fail messages.

Block 350 provides for responding to received messages via the chat session responsive to a predetermined set of questions. Specifically, an embodiment provides that if the test client is online, a user that is included in a chat session can ask the client one or more questions regarding the status of the test. The API can include a dictionary of key words that can invoke a response from the test client and provide a status message to the user. For example, if the test program has markers therein, the dictionary can be loaded with those relevant key words indicative of the status at that point identified by the marker.

The programmable API enables the test computer or test program to be set up to send real-time messages to users concerning the status of the machine, test or processes that are running on the machine, series of machines, or computing environment. More particularly, the chat application disseminates results in near “real-time”. Depending on how the programmable API is set up, the chat application can send an instant message to each user identified on a contacts list for the machine, test or process such that a message would appear on each contact computer that is logged in to a chat application.

Thus, the test computer interfaces with the chat server and is able to display the same status as any other chat contact. The “test” client can display such state information as “active,” “away,” “do-not-disturb” and the like to indicate the state of a test. For example, if a “test” system is available for testing purposes, the contact list could identify the “test” system as “available.” Likewise, if the “test” system is not available, the contact list could identify the “test” system as “online but away” or “do not disturb”.

In one embodiment, the programmable API enables the test computer to send real time results to other users identified on the chat server. The API sends specific information in the message, such as links to create an FTP of a virtual desktop connection to the machine so that the person receiving the message could have direct access to the target test computer.

In another embodiment, the API provides a method for the test computer to perform multiple invites for a group of individuals to evaluate the messages and immediately have a location and chat session open to discuss.

According to embodiments described herein, to implement a chat session, one or more computers shown in FIG. 2 include an instant messaging client application. More particularly, a client can include a test infrastructure/client that has a method for interacting and receiving results from a test computer. Either a chat client/server interface or another infrastructure performs The computer-implemented method for interacting and receiving results client as one of skill in the art will appreciate will benefit from the present disclosure. In an embodiment, the chat client instantiates as a process as a class of computer program that runs in the background, rather than under the direct control of a user.

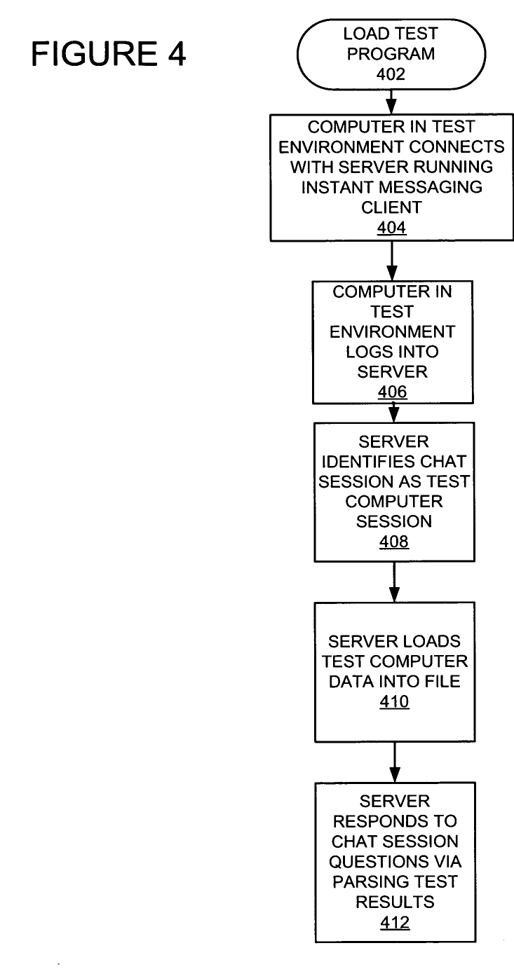

Referring now to FIG. 4, a method is illustrated that discloses an embodiment for operating a computer operating in a test environment as a client computer to connect with a server with the capability of automatically contacting users on a user list of test result information and the like. Block 402 provides for a computer operating in a test environment to load a test program for opening an instant messaging client. Block 404 provides for the computer operating in the test environment to connect with a server operating an instant messaging client. Once the computer operating in the test environment is connected to the server, block 406 provides for having the computer operating in the test environment to log into the server. The computer operating in the test environment sends the server the connection information, which can include IP address and number of the port assigned to a chat client. The server can also provide the user names present on an associated contacts list.

Typically, the server creates a temporary file that has the connection information for a user and the list of contacts. The server can check to see if any of the users in a contact list are currently logged in and highlight those available for instant messaging, by providing the connection information for those users, such as whether the users are idle, active or the like. Likewise, the server can send the client connection information to those users on the list of contacts that are signed on. According to an embodiment, the temporary file is used to identify the test computer and provide test results. More particularly, block 408 provides for, after loggings into the server, having the computer operating in the test environment identify a chat session as a test computer session. Once identified as a test computer session, a script loaded on the test computer can download results to the temporary file or other appropriate file that can be queried by users that are part of the chat session, including users present or not present during the chat. Thus, block 410 provides for loading test computer results onto an appropriate file, such as a temporary file. The file can be on the chat server or on the computer operating in the test environment. Where ever located, for efficiency or for other purposes, the test results loaded for access via a chat session can be organized to be responsive to a chat application. More specifically, the results can be organized to enable parsing. Block 412 provides for parsing the test results after receiving chat session questions from the chat session. The temporary file can be accessed via a query application included in the chat application, disposed within a server, or in a location appropriate as one of skill in the art with the benefit of this disclosure will appreciate. The parsed questions can be associated with a list of responses. For example, if a result is unexpected or a failure, a response could include a failure response or an indication that the test needs to be repeated.

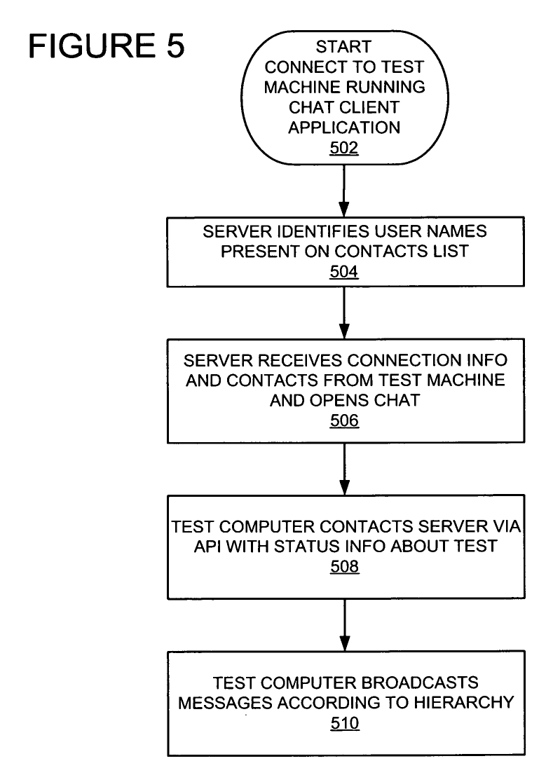

Referring now to FIG. 5, a flow diagram illustrates a method that could be performed by a server to monitor a test computer in accordance with an embodiment. As shown, block 502 provides for enabling a computer in a test environment or a computer logged into the test environment according to a predetermined security protocol to connect to a test computer running a client application for instant messaging. Block 504 provides for having the test computer identify user names present on an associated contacts list for the test computer user. Block 506 provides for the server to receive connection information from the test computer user and a list of contacts and to open a chat session. Block 508 provides that a script running on the test computer causes test computer to contact the server via an API or other appropriate communication method, either periodically or upon predetermined events server with status information concerning a test or with result information. Block 510 provides for having the test computer broadcast the messages received by the server to attendees of the chat session. According to one embodiment, the test computer or the server as directed by the test computer broadcasts messages according to a hierarchy provided by the test computer to the server such that some messages are broadcast to all attendees, and other messages are reserved for certain users in accordance with the hierarchy. Thus, for example, a supervisor may be interested in only test result information and not status information. Such a supervisor would receive only test result information as directed by the hierarchy.

While the invention has been shown and described with reference to particular embodiments thereof, it will be understood by those skilled in the art that the foregoing and other changes in form and detail may be made therein without departing from the spirit and scope of the invention, including but not limited to additional, less or modified elements and/or additional, less or modified steps performed in the same or a different order.

We claim:

1. A computer-implemented method for acquiring test results from one or more tests performed in a computer test environment including at least one test computer, the computer-implemented method comprising:
receiving by a server a request from a computer in the computer test environment to instantiate a chat session with the test computer in the computer test environment wherein the server hosts an instant messaging service, the request identifying the test computer as a chat user;
instantiating a chat session in response to the request between the test computer and at least one computer in the computer test environment;
accessing data concerning test results performed on the test computer by the server to enable responding to chat session data requests; and
responding to chat requests by one or more participants to the chat session via parsing the data concerning the test results accessed by the server.

2. The computer-implemented method of claim 1 wherein the data concerning the test computer includes one or more test results and test status of a test program running on at least the test computer.

3. The computer-implemented method of claim 1 further comprising:
broadcasting one or more messages from the test computer to the one or more participants, wherein the broadcasting is according to a hierarchy supplied by the test computer, the hierarchy identifying participants in an order to receive the messages and matching appropriate participants to a subset of the messages, the broadcasting being performed periodically or in accordance with markers present in a test program.

4. The computer-implemented method of claim 1 wherein the data concerning the test computer includes test data loaded on the test computer or the server, the data concerning the test computer being configured to be accessed via a chat session and configured to be parsed.

5. A computer-implemented method for a test computer to disseminate test result data, the computer-implemented method comprising:
instantiating by one or more computers in a computer test environment a chat session independent of human interaction via an application programming interface (API) as a function related to invoking a test on the test computer;
contacting by the one or more computers in a computer test environment predetermined users as participants to the chat session; and
sending by the one or more computers in a computer test environment one or more messages to one or more of the participants via the API in response to markers present in a test program running on the test computer.

6. The computer-implemented method of claim 5 wherein the function results in the chat session being instantiated upon occurrence of one or more of the invoking the test, a predetermined time after the invoking the test, reaching one or more markers included in the test, or receiving an indication to instantiate the chat session in response to test parameters determined after invoking the test.

7. The computer-implemented method of claim 5 wherein the API interacts with a script identifying the participants to be sent the one or more messages.

8. The computer-implemented method of claim 5 further comprising:
responding to messages received by one or more of the participants via a predefined set of responses associated with a status of the test.

9. The computer-implemented method of claim 5 wherein the markers cause the API to deliver predetermined messages via a chat application.

10. The computer-implemented method of claim 8 wherein the API is configured to access a dictionary of key words, the key words invoking a real-time response from the test computer to provide a response to the participant sending a message.

11. A computer system comprising:
a processor;
a memory coupled to the processor, the memory including a module configured to enable an interactive chat session between to one or more participants of a chat session and one or more computers in a computer test environment, the module configured to identify the computer system as a chat user and as one of the one or more computers in the computer test environment and instantiate the chat session to enable near real time access by one or more participants of the chat session of data concerning testing by a test computer in a computer test environment.

12. The computer system of claim 11 wherein the module is configured to access a dictionary of key words, the key words invoking a near real-time response from the test computer to provide a response to a participant in the chat session sending a message.

13. The computer system of claim 11 wherein the module is configured to enable disseminating test result data from the test computer, the module including:
an application programming interface (API) responsive to instantiation of a chat session independent of human interaction by invoking a test on the test computer, the API configured to contact predetermined users as participants to the chat session.

14. The computer system of claim 13 wherein the API is configured to respond in near real-time to the one or more participants of the chat session to provide the data concerning the testing by the test computer in the computer test environment.

15. The computer system of claim 13 wherein the API is configured to interact with a script identifying the participants to the chat session.

16. The computer system of claim 13 wherein the API is configured to respond to one or more messages received by the one or more of the participants in the chat session via a predefined set of responses associated with a status of the test.

17. The computer system of claim 13 wherein the API is configured to contact the one or more participants in the chat session as a function of one or more markers present in a test program running on the test computer.

18. The computer system of claim 17 wherein the markers cause the API to deliver predetermined messages via a chat application.
